(19) United States
(12) Patent Application Publication
(10) Pub. No.: US 2012/0042794 A1
(43) Pub. Date: Feb. 23, 2012

(54) Method and apparatus for using a flat bed printer for applying UV-sensitive ink to artificial fingernail tips

(76) Inventor: Quoc N. Tran, Huntington Beach, CA (US)

(21) Appl. No.: 12/806,833

(22) Filed: Aug. 23, 2010

(51) Int. Cl. B41F 17/28

(52) U.S. Cl. 101/41

(57) ABSTRACT

A method and apparatus by which a conventional flat bed printer is used to print artwork, images and similar decorative designs on artificial fingernail tips. A jig template having a matrix of compartment is laid upon the print bed of the flat bed printer. A fingernail tip bone support having an array of seats is inserted within each compartment of the template. A fingernail tip bone having an array of fingernail tips to be printed is detachably connected to each fingernail tip bone support so that the array of fingernail tips are seated on respective ones of the array of seats. The print head carriage of the flat bed printer is moved over the print bed and above the jig template so that ink from print heads of the carriage is applied to the array of fingernail tips within each compartment of the template.

### BACKGROUND OF THE INVENTION

1. Field of the Invention

This invention relates to a method and apparatus by which a conventional flat bed printer is used to print artwork, images and similar decorative designs on arrays of artificial fingernail tips of the kind that are attached to a wearer's fingernails. Unique combinations of a fingernail tip bone support and a fingernail tip bone are inserted into compartments of a jig template to facilitate the printing process.

2. Background Art

Individuals often wish to lengthen their fingernails by attaching (e.g., adhesively bonding) artificial tips thereto. In order to enhance the ornamentality of the fingernail tip attachments, decorative artwork is often illustrated. Such artwork is commonly printed in ink that is applied by means of standard brushes, air brushes, absorbent pads, ink jet printers and the like. In some cases, the artwork is applied by hand which is time-consuming, labor-intensive and difficult to accurately reproduce on a large number of fingernail tips. Because of the detail required for application to a small surface area, the nature of the artwork is limited. Moreover, it has been found that the ink printed on the fingernail tips by such common techniques does not bond well and is known to smear, whereby the artwork may be obliterated. Therefore, it would be desirable to be able to reliably print decorative artwork on a large number of fingernail tips in an efficient, uniform manner so that the ink will adhere and the artwork will be preserved.

Flat bed printers are commonly used to print signs, banners and other large generally flat displays. However, as far as it is known, a conventional flat bed printer has not heretofor been used to apply ink to large numbers of small curved objects, such as arrays of fingernail tips.

### SUMMARY OF THE INVENTION

In general terms, a method and apparatus are disclosed by which a commercially-available flat bed printer is used for printing artwork, images and similar decorative designs on arrays of artificial fingernail tips of the kind that are attached to a wearer's fingernails. The flat bed printer includes a print head carriage which carries print heads and a pair of UV light tubes longitudinally along and laterally across a flat print bed. A print head motor supplies UV-sensitive ink from an ink source to the print heads.

In accordance with a preferred embodiment, a jig template is laid on the print bed of the flat bed printer. The template has a matrix of compartments. Inserted within each compartment of the template is the combination of a fingernail tip bone support and a fingernail tip bone. The nail tip bone support has a pair of spaced parallel-aligned rows of arcuate nail seats. A series of pin holes are formed in the nail tip bone support. The nail tip bone has a pair of spaced parallel-aligned rows of curved fingernail tips. Alignment pins project from the bone for removable receipt by the pin holes of the bone support so that the fingernail tip bone is detachably connected to the finger nail tip bone support and the curved fingernail tips of the bone lay flush against respective ones of the arcuate fingernail seats of the bone support.

A spacer is located between the print heads of the print head carriage and the print bed of the flat bed printer on which the template is laid so that the initial position of the print heads can be established above and in close proximity to the fingernail tips to be printed with the UV-sensitive ink. Once the position of the print heads is established, the spacer is removed. During the printing process, the UV light tubes generate light to cause the ink to cure and adhere to the fingernail tips. At the conclusion of the printing process, the fingernail tip bone support and the fingernail tip bone combinations are removed from the compartments of the template. The printed fingernail tips are then separated from their fingernail tip bones for distribution and use.

### BRIEF DESCRIPTION OF THE DRAWINGS

FIG. 1 shows a commercially-available flat bed printer which is used for printing decorative designs on arrays of artificial fingernail tips to achieve the advantages of this invention;

FIG. 2 is a front view of a print head carriage of the flat bed printer of FIG. 1 having print heads and a pair of UV light tubes;

FIG. 3 is a side view of the print head carriage of FIG. 2;

FIG. 4 illustrates a jig template having a matrix of compartments to be laid on a print bed of the flat bed printer of FIG. 1;

FIG. 5 shows the jig template of FIG. 4 laying upon the print bed of the flat bed printer;

FIG. 6 shows a fingernail tip bone to be detachably connected to a fingernail tip bone support and inserted within each compartment of the jig template of FIG. 4;

FIG. 7 shows a combination of the fingernail tip bone connected to the fingernail tip bone support of FIG. 6; and

FIG. 8 shows the print heads of the print head carriage of the flat bed printer positioned above nail tip bone support and nail tip bone combinations like that shown in FIG. 7.

### DESCRIPTION OF THE PREFERRED EMBODIMENT

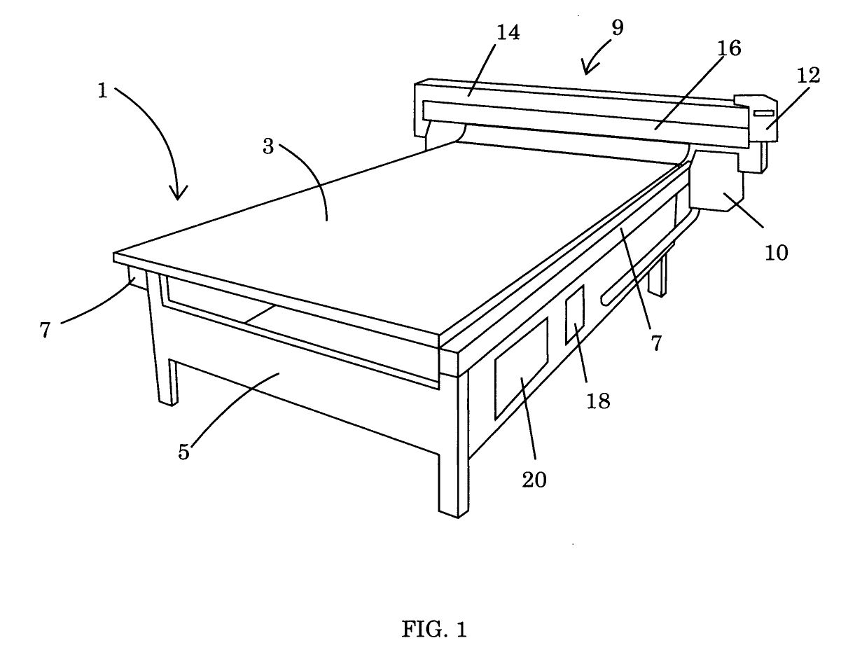

The method and apparatus by which a flat bed printer and UV-sensitive ink are used for printing artwork, images and similar decorative designs on arrays of artificial fingernail tips is initially described while referring to FIGS. 1-3 of the drawings where there is shown a flat bed printer 1 of the kind that is typically used for printing signs, banners, and similar flat displays. One suitable flat bed printer having a wide-format inkjet head which can be used to practice the present invention is known commercially as “Solara ion” by Gerber Scientific Products of South Windsor, Conn. Because the flat bed printer 1 shown in FIGS. 1-3 is commercially available, only a brief description of the relevant details will be provided below.

Turning first to FIG. 1, the flat bed printer 1 includes a horizontal print bed 3 that is supported by a table 5. A pair of guide rails 7 run along opposite sides of the print bed 3 atop the table 5. A print head carriage 9 is disposed at one end of the table 5 and coupled to the guide rails 7 so as to ride along the rails and move in a first longitudinal direction over the print bed 3. A motor 10 and a motor controller 12 are carried by the print head carriage. Thus, the motor 10 and controller 12 ride along with the print head carriage 9 in the first longitudinal direction over the print bed 3.

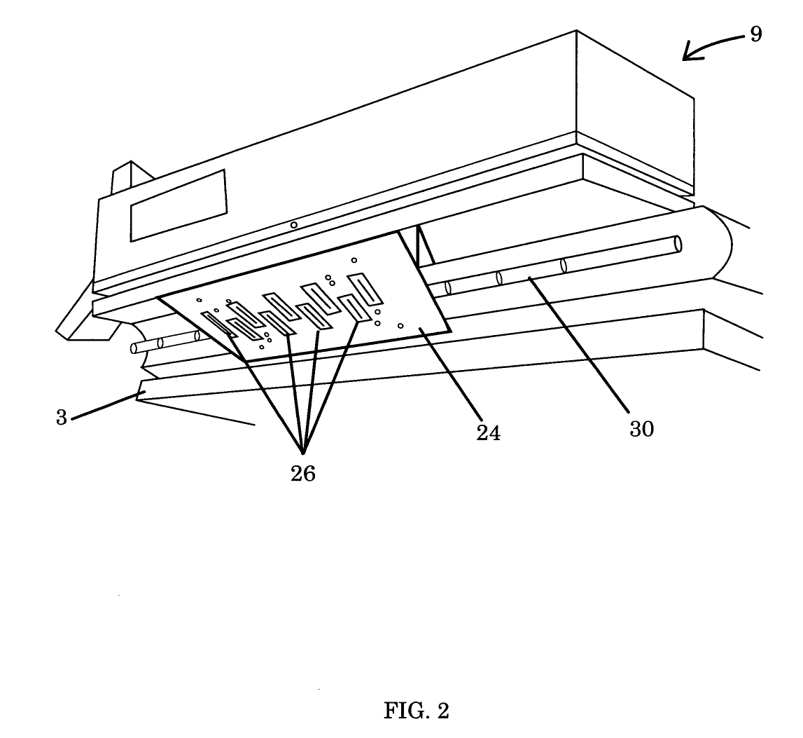

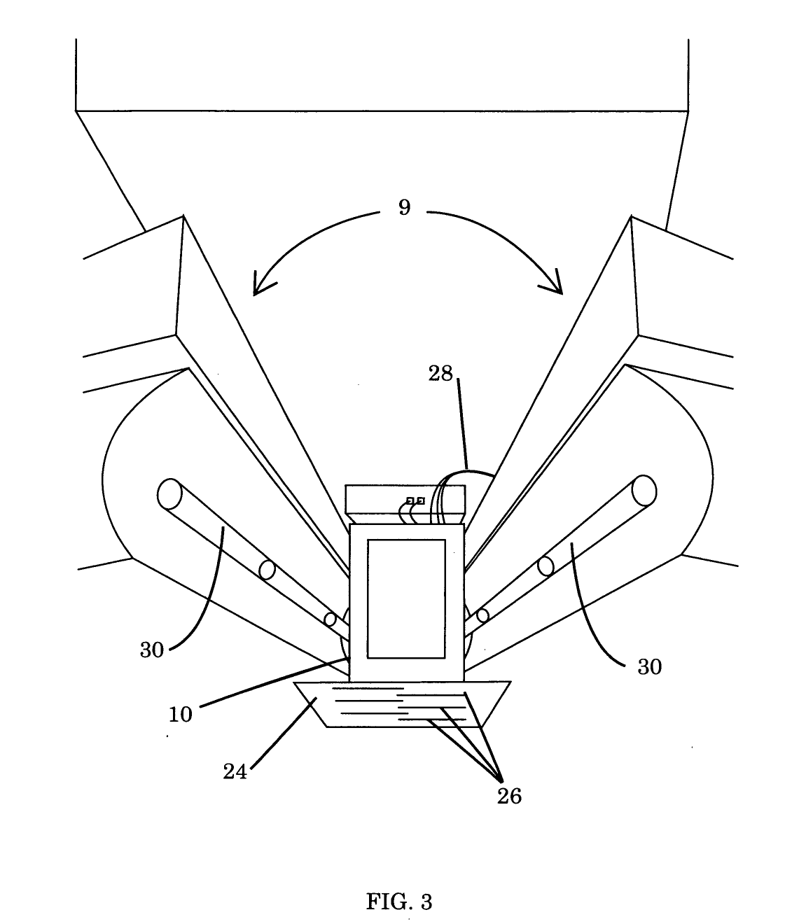

A removable print head carriage cover 14 surrounds the print head carriage 9. A cover plate 16 is detachably connected to the print head carriage 9 across the face of the carriage cover 14. As will be described in greater detail when referring to FIGS. 2 and 3, a plurality of print heads (designated 26 in FIGS. 2 and 3) and a pair of UV light tubes (designated 30) lie behind the cover plate 16 of print head carriage 9. The motor 10 is responsible for moving the print heads in a second lateral direction over the print bed 3 when ink is to be applied from an ink source to the arrays of fingernail tips. To this end, pouches (not shown) that are filled with UV-sensitive ink to be supplied to the print heads of the print head carriage 9 are loaded into drawers behind a first panel 18 of the table 5 of the flat bed printer 1. A motor (also not shown) is located behind a second panel 20 of the table 5. The motor behind panel 20 is responsible for moving the print head carriage 9 in the aforementioned first longitudinal direction over the print bed 3.

Turning now to FIGS. 2 and 3, a description is provided of the print head carriage 9 of the flat bed printer 1 shown in FIG. 1 with the carriage cover and the cover plate (designated 14 and 16 in FIG. 1) removed. The print head carriage 9 includes a print head mount 24 to which an array of print heads 26 is connected. The print head mount 24 is slidable in the aforementioned second lateral direction across the print bed 3 by the motor 10 (best shown in FIG. 3). The motor 10 also pumps a supply of UV ink from the ink pouches located behind the panel 18 of the table shown in FIG. 1 to the print heads 26 by way of ink carrying tubes 28 (also best shown in FIG. 3). The print head mount 24 and the print heads 26 thereof are moved by the motor 10 between a pair of spaced, parallel-aligned UV light tubes 30 which irradiate the ink applied to the fingernail tips with UV light for an advantage that will now be disclosed.

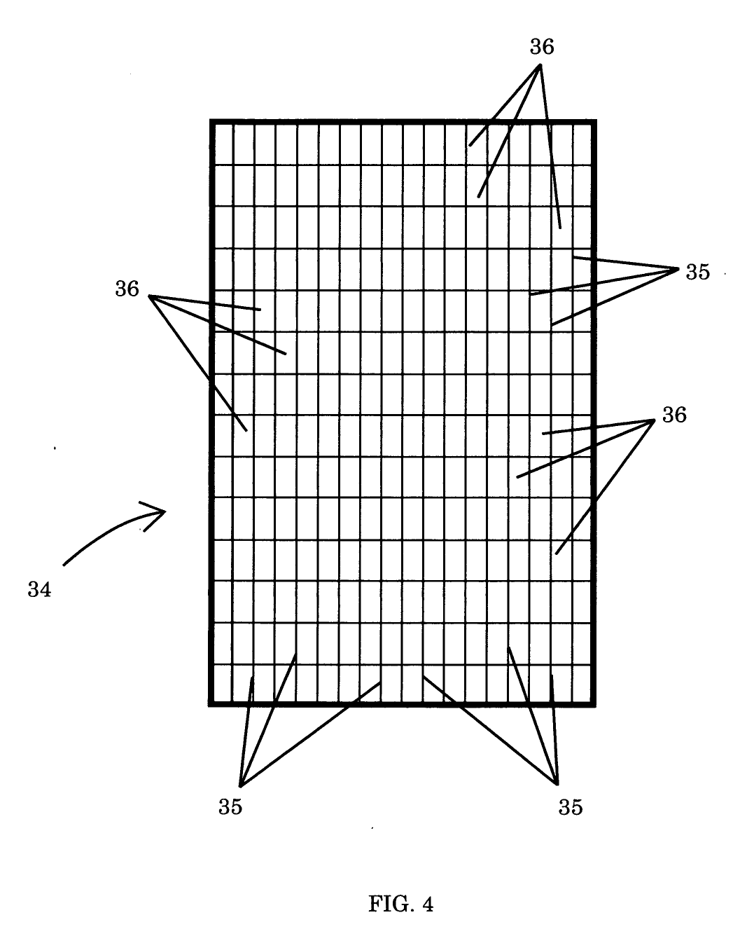

In accordance with a preferred embodiment of this invention, FIG. 4 of the drawings illustrates a rectangular jig template 34 that is sized to lie upon the print bed 3 of the table 5 and below the print head carriage 9 of the flat bed printer 1 of FIG. 1. By way of example only, for the particular flat bed printer earlier described, the template 34 has a length of 8 feet, a width of 6 feet, and a depth of 0.25 inches. The template 34 is preferably manufactured (e.g., laser cut) from sheet metal or plastic. The template 34 is formed by horizontal and vertical running ribs 35 which establish a matrix of empty compartments 36. Each empty compartment 36 is approximately 7 inches long and 3 inches wide. However, the dimensions of the template 34 and the compartments 36 are not to be considered a limitation of this invention.

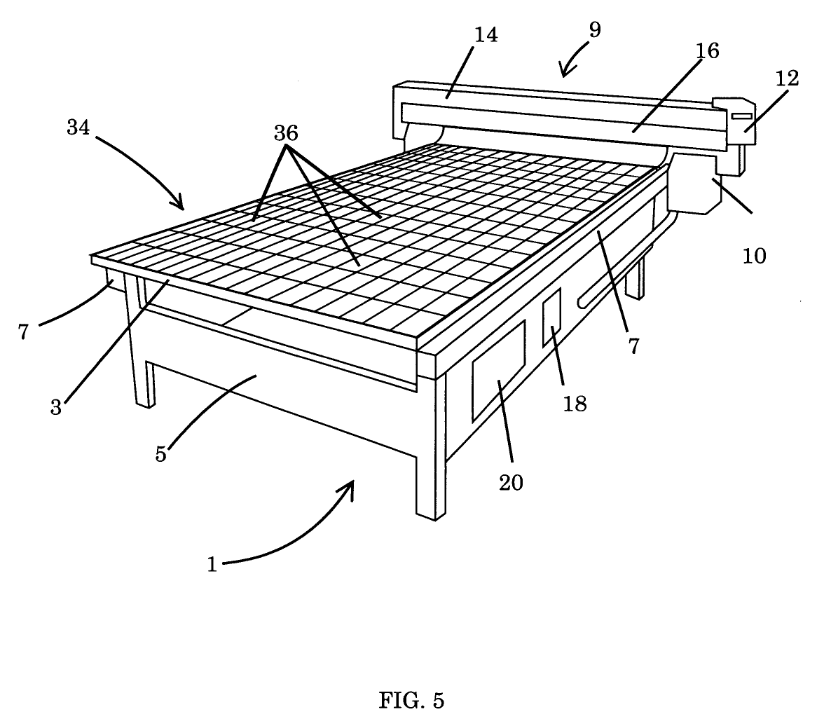

FIG. 5 of the drawings shows the rectangular jig template 34 of FIG. 4 lying flat against the print bed 3 of the table 5 of the flat bed printer 1. The empty compartments 36 of the template 34 are accessible for the removable receipt of respective combinations of fingernail tip supports and arrays of artificial fingernail tips on which artwork, images and similar designs are to be printed by the UV-sensitive ink supplied to the print heads 26 of the print head carriage 9 of FIGS. 2 and 3.

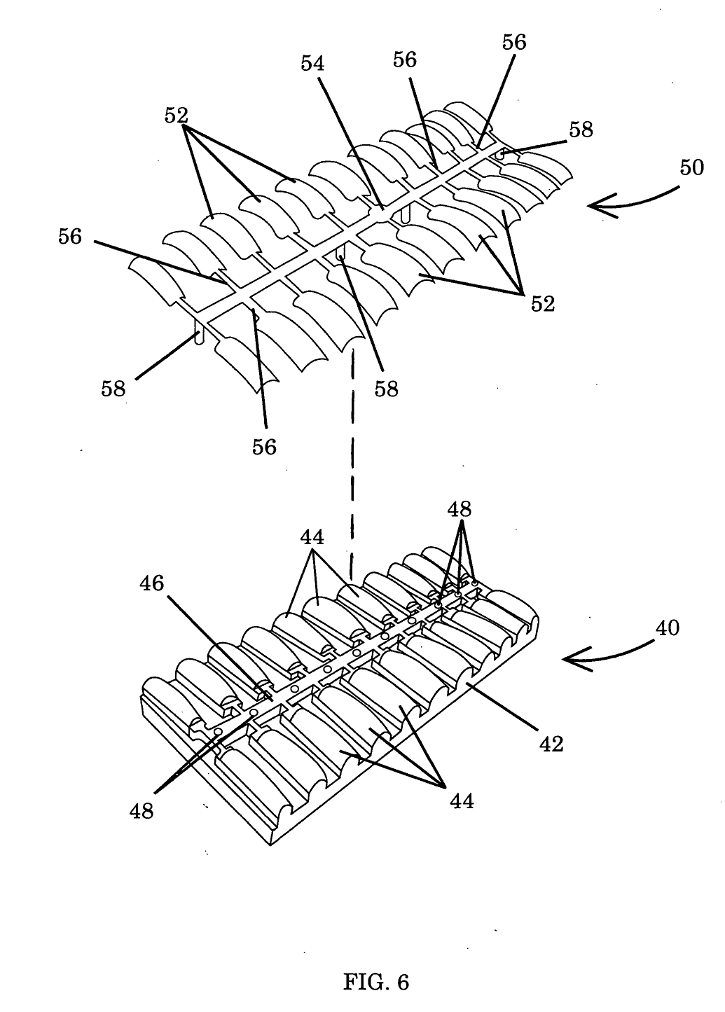

Referring in this regard to FIG. 6 of the drawings, the combinations to be inserted into each one of the compartments 36 of the jig template 34 are illustrated. A fingernail tip bone support 40 has a molded body 42 with dimensions that correspond to the size of each compartment 36. The bone support 40 includes a pair of parallel-aligned rows of nail seats 44. The nail seats 44 are spaced from one another at the top of the body 42. The nail seats 44 are joined to and extend outwardly from opposite sides of a rail 46 that runs longitudinally along the body 42 of the nail tip bone support 40. A series of spaced pin holes 48 are formed in the rail 46. The nail seats 44 have a generally arcuate shape that conforms to the shape of a typical fingernail tip so that the fingernail tips to be printed with ink will lie flush upon and be supported by the seats 44.

FIG. 6 also shows a fingernail tip bone 50 having an array of curved fingernail tips 52. Like the bone support 40, the fingernail tip bone 50 includes two rows of spaced, parallel-aligned fingernail tips 52. The fingernail tips 52 are attached by means of joints 56 to opposite sides of a runner 54 that runs longitudinally along fingernail tip bone 50. The joints 56 at which the tips 52 are connected to the runner 54 are relatively narrow to permit the tips 52 to be twisted or pulled off the runner 54 at the conclusion of the printing process.

So that the fingernail tips 52 that are carried by the fingernail tip bone 50 are aligned to be laid upon respective ones of the seats 44 of the molded body 42 of the fingernail tip bone support 40, a number of alignment pins 58 project downwardly from the runner 54 of bone 50. The alignment pins 58 are spaced from one another for receipt within the pin holes 48 formed in the rail 46 of bone support 40.

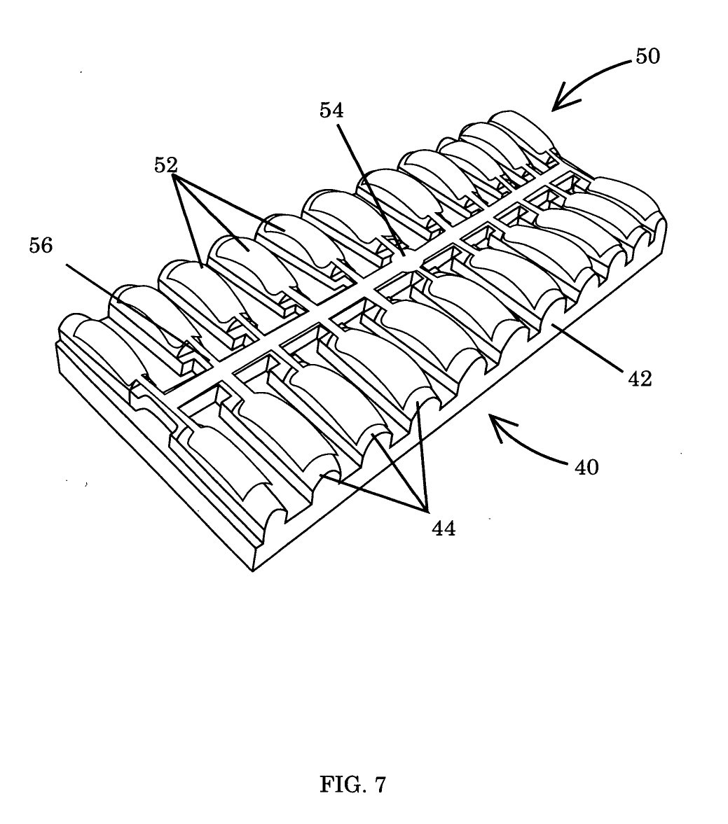

FIG. 7 of the drawings shows the fingernail tip bone 50 of FIG. 6 lying over and detachably connected to the fingernail tip bone support 40 after the alignment pins 58 are located in the pin holes 48. Thus, the curved fingernail tips 52 are laid flush upon and supported by the arcuate finger nail seats 44. As previously explained, each combination fingernail tip bone support 40 and fingernail tip bone 50 is inserted within one compartment 36 of the jig template 34 of FIG. 4. The maximum height of the base 42 of the bone support 40 at the fingernail seats 44 thereof (e.g., about 0.5 inches) is selected so that the fingernail tips 52 carried by the bone 50 are raised slightly above the compartment 36 in order to receive ink from the print heads 26 of the print head carriage 9 shown in FIG. 2.

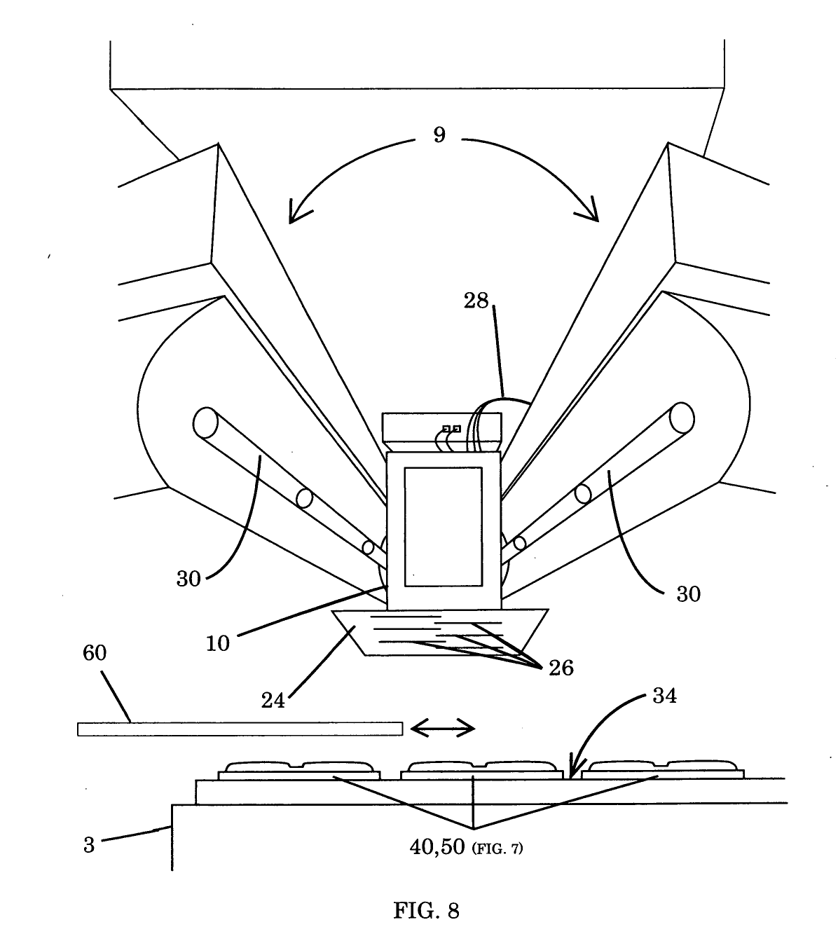

In this regard, FIG. 8 of the drawings shows the print bed 3 of the flat bed printer (designated 1 in FIG. 5) with the template 34 lying thereon so that the combinations of the fingernail tip bone support 40 and the fingernail tip bone 50 (of FIG. 7) inserted within the compartments 36 of template 34 are positioned under the print heads 26 of the print head mount 24 of the print head carriage 9. As was previously indicated, the print head motor 10 of print head carriage 9 draws ink to the print heads 26 and moves the print head mount 24 laterally above the template 34 while the print head carriage 9 is moved longitudinally along the print bed 3 so that UV-sensitive ink can be applied to the fingernail tips. By way of example only, one suitable ink to be applied to the fingernail tips (52 of FIG. 6) by means of a conventional adhesion printing process is a flexible cationic UV-sensitive ink available from Gerber Scientific Products. In this case, UV light provided by the light tubes 30 of the print head carriage 9 promotes curing which causes the ink to reliably adhere to the nail tips 52 and thereby prevent smearing. During the printing process, a vacuum pump (not shown) of the flat bed printer 1 generates a suction force for holding the template 34 against the print bed 3 to prevent a displacement thereof relative to the print heads 26.

To ensure a reliable and uniform application of ink to the fingernail tips 52, a spacer 60 is used to set the initial distance of the print head mount 24 above the template 34 so that the print heads 26 are disposed in close spaced proximity to the arrays of fingernail tips 52 carried by the fingernail tip bones 50 which are detachably connected to fingernail tip bone supports 40. In particular, the spacer 60 is preferably located on the print bed 3 behind the template 34 and below the print head mount 24. The spacer 60 is ideally rectangular with straight top and bottom edges so as to create a flat reference surface above the curved fingernail tips 52.

The print head carriage 9 which carries the print head mount 24 is lowered hydraulically against the spacer 60 until the print heads 26 lie over and immediately adjacent the arrays of fingernail tips 52 that have been inserted into and stand upwardly from the compartments 36 of the template 34. Once the initial position of the print head mount 24 is established, the spacer 60 is removed so that the printing process can begin. The precise design to be printed on the fingernail tips 52 is selectively controlled by software that enables data to be supplied from a remote computer by way of a data link cable (not shown) to the motor controller 12 of the flat bed printer 1. At the conclusion of the printing process, the fingernail tip bone support and fingernail tip bone combinations 40, 50 are removed from the compartments 36 of the template 34. The printed fingernail tips 52 are then separated from the runners 54 of the bones 50 for distribution and use.

1. A combination comprising:
a flat bed printer including a print bed and a print head carriage movable over the print bed, said print head carriage having a print head which communicates with an ink source to receive a supply of ink therefrom;
a fingernail tip bone support to be laid upon the print bed of said flat bed printer; and
at least one fingernail tip bone having an array of fingernail tips which lie upon said fingernail tip bone support, the fingernail tips of said fingernail tip bone receiving ink supplied to the print head of said print head carriage as said print head carriage moves over the print bed above said bone.

2. The combination recited in claim 1, wherein said fingernail tip bone support has a plurality of pin holes formed therein and said fingernail tip bone has a corresponding plurality of alignment pins projecting therefrom for the removable receipt by respective ones of said pin holes, whereby said fingernail tip bone is detachably connected to and lies upon said fingernail tip bone support.

3. The combination recited in claim 2, wherein said fingernail tip bone support includes an array of spaced, parallel-aligned fingernail tip seats, the array of fingernail tips of said fingernail tip bone being seated on respective ones of the array of fingernail tip seats of said fingernail tip bone support when said bone is detachably connected to said bone support.

4. The combination recited in claim 3, wherein each one of the array of fingernail tips of said fingernail tip bone is curved and each one of the array of fingernail tip seats of said fingernail tip bone support has an arcuate shape, whereby the array of fingernail tips are seated flush against the array of fingernail tip seats.

5. The combination recited in claim 1, further comprising a template to be laid upon the print bed of said flat bed printer, said template having at least one compartment within which to removably receive said fingernail tip bone detachably connected to said fingernail tip bone support.

6. The combination recited in claim 5, wherein said template has a plurality of compartments, each of said compartments removably receiving one of a plurality of said fingernail tip bones detachably connected to one of a corresponding plurality of said fingernail tip bone supports.

7. The combination recited in claim 5, wherein said template is sized to lie below the print head carriage of said flat bed printer so that the print head of said print head carriage is located over top said template as said print head carriage moves over the print bed of said printer.

8. For a flat bed printer including a print bed and a print head carriage movable over the print bed, said print head carriage having a print head which communicates with an ink source to receive a supply of ink therefrom, the improvement comprising:
a template having a plurality of compartments formed therein, said template to be positioned upon the print bed of said flat bed printer so as to lay below the print head carriage as said carriage moves over the print bed;
a plurality of fingernail tip bone supports to be removably received within respective ones of the plurality of compartments of said template; and
a plurality of fingernail tip bones, each of which having an array of fingernail tips and lying upon a respective one of said plurality of fingernail tip bone supports within one of the plurality of compartments of said template, the arrays of fingernail tips of said plurality of fingernail tip bones receiving ink supplied to the print head of said print head carriage as said carriage moves over the print bed.

9. A method for printing ink on an array of fingernail tips by means of a flat bed printer that includes a print bed and a print head carriage movable across the print bed and having a print head which communicates with a source of ink to receive a supply of ink therefrom to be printed on the array of fingernail tips, said method comprising the steps of:
positioning a fingernail tip bone support upon the print bed of the flat bed printer;
positioning at least one fingernail tip bone having the array of fingernail tips to be printed with ink upon said fingernail tip bone support; and
moving the print head carriage across the print bed and over said fingernail tip bone positioned on said fingernail tip bone support so that the array of fingernail tips are printed with the ink supplied to the print head of the print head carriage.

10. The method recited in claim 9, comprising the additional steps of forming a plurality of pin holes in said fingernail tip bone support and a corresponding plurality of alignment pins on said fingernail tip bone; and locating said plurality of alignment pins in respective ones of said plurality of pin holes, whereby said fingernail tip bone is detachably connected to said fingernail tip bone support and said array of fingernail tips are seated on said bone support.

11. The method recited in claim 10, comprising the additional step of forming an array of spaced, parallel-aligned seats on said fingernail tip bone support; and seating said array of fingernail tips of said fingernail tip bone on respective ones of said array of seats when said fingernail tip bone is detachably connected to said fingernail tip bone support.

12. The method recited in claim 11, comprising the additional steps of laying a template upon the print bed of said flat bed printer, said template having at least one compartment; and removably locating within said compartment said fingernail tip bone detachably connected to said fingernail tip bone support, the print head carriage of said flat bed printer moving over top said template.

13. The method recited in claim 12, comprising the additional steps of forming said template with a plurality of compartments; and removably locating within each of said compartments one of a plurality of said fingernail tip bones detachably connected to one of a corresponding plurality of said fingernail tip bone supports.

14. The method recited in claim 9, comprising the additional steps of locating a spacer between the print bed of said flat bed printer and the print head of said print head carriage; moving said print head carriage against said spacer such that the print head lies in spaced proximity above the arrays of fingernail tips of said plurality of fingernail tip bones; and removing said spacer.
